(19) United States
(12) Patent Application Publication
(10) Pub. No.: US 2017/0011139 A1
(43) Pub. Date: Jan. 12, 2017

(54) PHYSICALLY-AWARE CIRCUIT DESIGN PARTITIONING

(71) Applicant: Mentor Graphics Corporation, Wilsonville, OR (US)

(72) Inventors: Harm Arts, Saratoga, CA (US); Changbo Long, San Jose, CA (US); Paul van Besouw, San Jose, CA (US)

(21) Appl. No.: 15/204,896

(22) Filed: Jul. 7, 2016

Related U.S. Application Data
(60) Provisional application No. 62/189,649, filed on Jul. 7, 2015.

(51) Int. Cl. G06F 17/50

(52) U.S. Cl. CPC G06F 17/505; G06F 17/5072

(57) ABSTRACT

This application discloses a computing system implementing a synthesis tool to synthesize a circuit design of an electronic system into a gate-level netlist having a logical hierarchy, utilize the gate-level netlist to generate a physical representation of the circuit design, and partition the circuit design into sub-designs based on the physical representation of the circuit design. The computing system can generate physical modules having self-contained physical definitions from the sub-designs, and reassemble the physical modules into a gate-level netlist having a physical hierarchy corresponding to the partitions of the circuit design. The computing system also can regroup modules in the circuit design based on the physical hierarchy, modify the circuit design to have the physical hierarchy based on the regrouped modules, and synthesize the modified circuit design into the gate-level netlist having the physical hierarchy.

### RELATED APPLICATION

This application claims priority and benefit of U.S. Provisional Patent Application No. 62/189,649, filed, Jul. 7, 2015, which is incorporated by reference herein in its entirety.

### TECHNICAL FIELD

This application is generally related to electronic design automation and, more specifically, to physically-aware circuit design partitioning.

### BACKGROUND

Designing and fabricating electronic systems typically involves many steps, known as a design flow. The particular steps of a design flow often are dependent upon the type of electronic system being designed, its complexity, the design team, and the fabricator or foundry that will manufacture the electronic system. The design flow typically starts with a specification for a new electronic system, which can be transformed into a logical design. The logical design can model the electronic system at a register transfer level (RTL), which is usually coded in a Hardware Design Language (HDL), such as System Verilog, Very high speed integrated circuit Hardware Design Language (VHDL), System C, or the like. The logical design of the electronic system can be analyzed to confirm that it will accurately perform the functions desired for the electronic system. This analysis is sometimes referred to as “functional verification.”

After the accuracy of the logical design is confirmed, a synthesis tool can convert the logical design into a netlist. The netlist can describe gate-level components and their associated connectivity using cells from a process technology library. A designer, for example, using a place-and-route tool, can utilize the netlist and associated process technology library to place components of the netlist relative to each other in a geographic design environment or layout design. After placement, wiring lines can be routed between the placed components. These wiring lines represent the interconnections, such as data signal interconnections, clock signal interconnections, power connections, which can be formed between the components of the electrical system.

Many place-and-route tools, prior to placing components in the layout design, can perform floorplanning, which corresponds to a schematic representation of a tentative placement for the components in the layout design. The floorplan can determine where components in the netlist should be placed in a layout design based on a variety of goals, such as availability of space in the layout design, performance or speed of the electronic system, or the like. These place-and-route tools can arrange components into manageable sized groups for placement, which can allow the place-and-route tools to efficiently perform placement and routing operations.

When the place-and-route tools have difficulty achieving layout design closure, for example, generate a layout design implementing the netlist that meets the specifications for the electronic system, designers usually revert back to the logical design portion of the design flow. These designers can modify the logical design and re-perform synthesis so the place-and-route tool can receive a different gate-level netlist to utilize in generating a new layout design for the electronic system. This iterative process can continue until the place-and-route tools are able to generate and close a layout design for the electronic system.

### SUMMARY

This application discloses a computing system implementing a synthesis tool to perform physically-aware circuit design partitioning. The computing system can synthesize a circuit design of an electronic system into a gate-level netlist having a logical hierarchy. The computing system can utilize the gate-level netlist to generate a physical representation of the circuit design. The computing system can partition the circuit design into sub-designs based on the physical representation of the circuit design. The computing system can partition the circuit design into sub-designs based on the physical representation of the circuit design. The computing system can generate a different gate-level netlist having a physical hierarchy corresponding to the partitions of the circuit design.

In some embodiments, the computing system can generate the different gate-level netlist by generating physical modules for the sub-designs and reassembling the physical modules into the different gate-level netlist. Each of the physical modules can have a self-contained physical definition. In some embodiments, the computing system can generate the different gate-level netlist by regrouping modules in the circuit design based on the physical hierarchy, modifying the circuit design to have the physical hierarchy based on the regrouped modules, and synthesizing the modified circuit design into the gate-level netlist having the physical hierarchy. Embodiments will be described below in greater detail.

### DESCRIPTION OF THE DRAWINGS

FIGS. 1 and 2 illustrate an example of a computer system of the type that may be used to implement various embodiments of the invention.

FIG. 3 illustrates an example of synthesis tool to perform physically-aware circuit design partitioning according to various embodiments of the invention.

FIG. 4 illustrates an example flowchart showing physically-aware circuit design partitioning according to various examples of the invention.

FIGS. 6A-6E illustrate examples of physically-aware circuit design partitioning according to various embodiments of the invention.

### DETAILED DESCRIPTION

### Illustrative Operating Environment

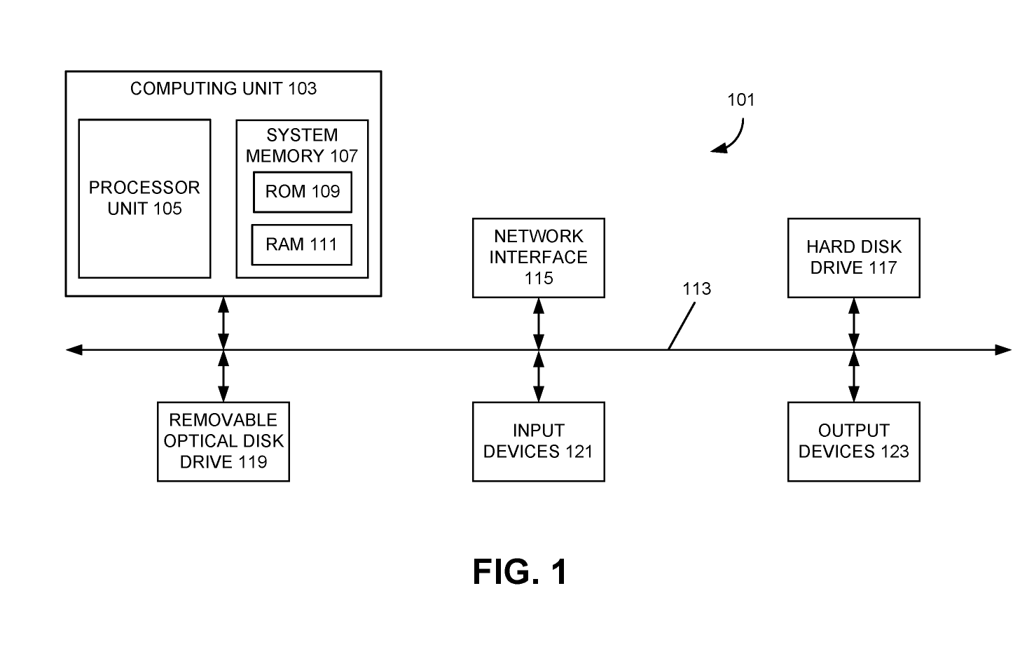

Various examples of the invention may be implemented through the execution of software instructions by a computing device 101, such as a programmable computer. Accordingly, FIG. 1 shows an illustrative example of a computing device 101. As seen in this figure, the computing device 101 includes a computing unit 103 with a processing unit 105 and a system memory 107. The processing unit 105 may be any type of programmable electronic device for executing software instructions, but will conventionally be a microprocessor. The system memory 107 may include both a read-only memory (ROM) 109 and a random access memory (RAM) 111. As will be appreciated by those of ordinary skill in the art, both the read-only memory (ROM) 109 and the random access memory (RAM) 111 may store software instructions for execution by the processing unit 105.

The processing unit 105 and the system memory 107 are connected, either directly or indirectly, through a bus 113 or alternate communication structure, to one or more peripheral devices 117-123. For example, the processing unit 105 or the system memory 107 may be directly or indirectly connected to one or more additional memory storage devices, such as a hard disk drive 117, which can be magnetic and/or removable, a removable optical disk drive 119, and/or a flash memory card. The processing unit 105 and the system memory 107 also may be directly or indirectly connected to one or more input devices 121 and one or more output devices 123. The input devices 121 may include, for example, a keyboard, a pointing device (such as a mouse, touchpad, stylus, trackball, or joystick), a scanner, a camera, and a microphone. The output devices 123 may include, for example, a monitor display, a printer and speakers. With various examples of the computing device 101, one or more of the peripheral devices 117-123 may be internally housed with the computing unit 103. Alternately, one or more of the peripheral devices 117-123 may be external to the housing for the computing unit 103 and connected to the bus 113 through, for example, a Universal Serial Bus (USB) connection.

With some implementations, the computing unit 103 may be directly or indirectly connected to a network interface 115 for communicating with other devices making up a network. The network interface 115 can translate data and control signals from the computing unit 103 into network messages according to one or more communication protocols, such as the transmission control protocol (TCP) and the Internet protocol (IP). Also, the network interface 115 may employ any suitable connection agent (or combination of agents) for connecting to a network, including, for example, a wireless transceiver, a modem, or an Ethernet connection. Such network interfaces and protocols are well known in the art, and thus will not be discussed here in more detail.

It should be appreciated that the computing device 101 is illustrated as an example only, and it not intended to be limiting. Various embodiments of the invention may be implemented using one or more computing devices that include the components of the computing device 101 illustrated in FIG. 1, which include only a subset of the components illustrated in FIG. 1, or which include an alternate combination of components, including components that are not shown in FIG. 1. For example, various embodiments of the invention may be implemented using a multi-processor computer, a plurality of single and/or multiprocessor computers arranged into a network, or some combination of both.

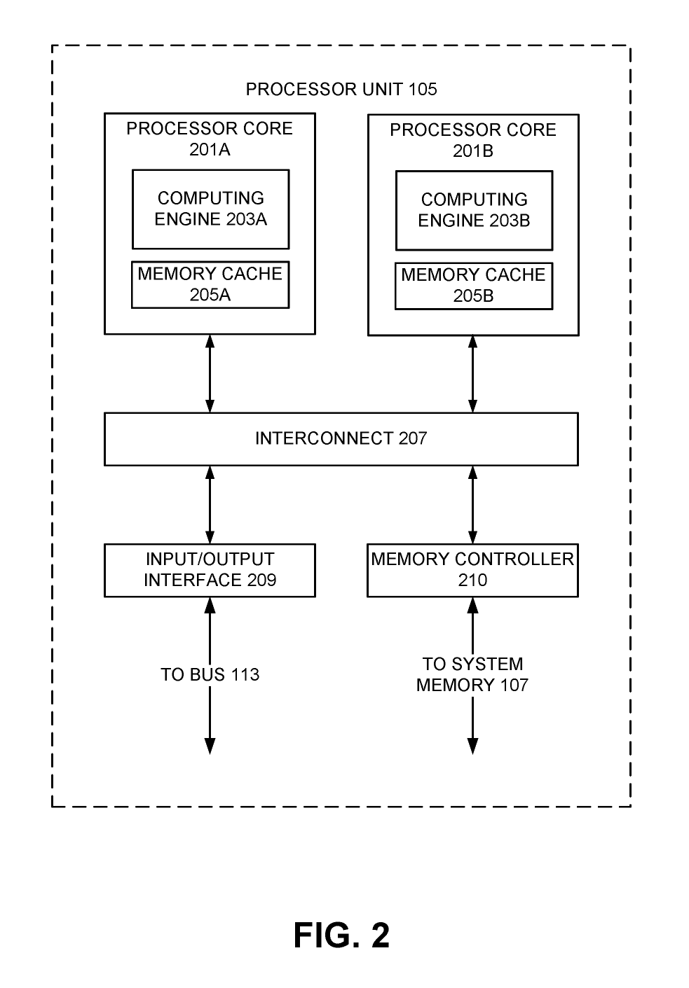

With some implementations of the invention, the processor unit 105 can have more than one processor core. Accordingly, FIG. 2 illustrates an example of a multi-core processor unit 105 that may be employed with various embodiments of the invention. As seen in this figure, the processor unit 105 includes a plurality of processor cores 201A and 201B. Each processor core 201A and 201B includes a computing engine 203A and 203B, respectively, and a memory cache 205A and 205B, respectively. As known to those of ordinary skill in the art, a computing engine 203A and 203B can include logic devices for performing various computing functions, such as fetching software instructions and then performing the actions specified in the fetched instructions. These actions may include, for example, adding, subtracting, multiplying, and comparing numbers, performing logical operations such as AND, OR, NOR and XOR, and retrieving data. Each computing engine 203A and 203B may then use its corresponding memory cache 205A and 205B, respectively, to quickly store and retrieve data and/or instructions for execution.

Each processor core 201A and 201B is connected to an interconnect 207. The particular construction of the interconnect 207 may vary depending upon the architecture of the processor unit 105. With some processor cores 201A and 201B, such as the Cell microprocessor created by Sony Corporation, Toshiba Corporation and IBM Corporation, the interconnect 207 may be implemented as an interconnect bus. With other processor units 201A and 201B, however, such as the Opteron™ and Athlon™ dual-core processors available from Advanced Micro Devices of Sunnyvale, Calif., the interconnect 207 may be implemented as a system request interface device. In any case, the processor cores 201A and 201B communicate through the interconnect 207 with an input/output interface 209 and a memory controller 210. The input/output interface 209 provides a communication interface to the bus 113. Similarly, the memory controller 210 controls the exchange of information to the system memory 107. With some implementations of the invention, the processor unit 105 may include additional components, such as a high-level cache memory accessible shared by the processor cores 201A and 201B. It also should be appreciated that the description of the computer network illustrated in FIG. 1 and FIG. 2 is provided as an example only, and it not intended to suggest any limitation as to the scope of use or functionality of alternate embodiments of the invention.

### Physically-Aware Circuit Design Partitioning

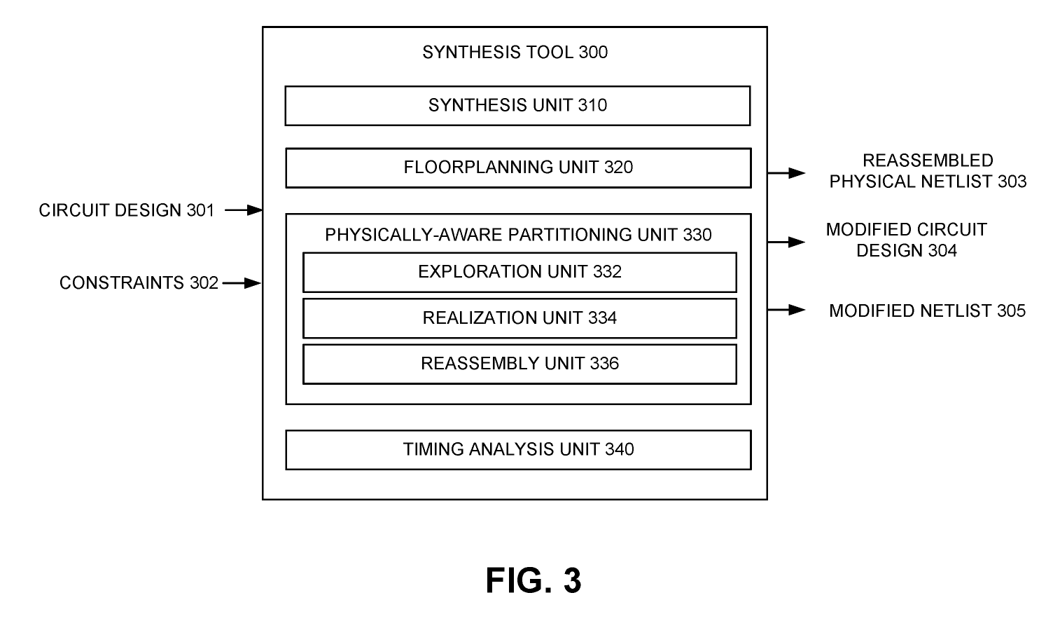

FIG. 3 illustrates an example of synthesis tool 300 to perform physically-aware circuit design partitioning according to various embodiments of the invention. Referring to FIG. 3, the synthesis tool 300 can receive a circuit design 301 modeling an electronic system at a register transfer level (RTL), for example, coded in a Hardware Design Language (HDL), such as System Verilog, Very high speed integrated circuit Hardware Design Language (VHDL), System C, or the like. The circuit design 301 can include multiple modules arranged in a logical hierarchy, for example, having a tree-structure with a top-level module as a root module. Embodiments of the logical hierarchy will be described below in greater detail. The synthesis tool 300 also can receive constraints 302 associated with the circuit design 301, such as timing constraints, power constraints, for example, specified in a unified power format (UPF) or the like, one or more libraries, for example, specified in a library exchange format (LEF), or the like.

The synthesis tool 300 can include a synthesis unit 310 to convert the circuit design 301 into a gate-level netlist based, at least in part, on the constraints 302. The gate-level netlist can describe connectivity of components in the electronic system described by the circuit design 301, while retaining the logical hierarchy of the circuit design 301. The synthesis tool 300 can include a floorplanning unit 320 to generate a physical representation of the circuit design 301. For example, the synthesis unit 310 can generate a floorplan of the circuit design 301, which can describe a tentative placement for the components in the gate-level netlist within a layout design.

The synthesis tool 300 can include a physically-aware partitioning unit 330 to identify a physical hierarchy in the physical representation of the circuit design 301, and then utilize the physical hierarchy to generate at least one netlist having modules organized according to the physical hierarchy, rather than organized according to the logical hierarchy in the circuit design 301. In some embodiments, the physically-aware partitioning unit 330 can utilize the physical hierarchy to partition the circuit design 301, the gate-level netlist, and/or the physical representation into multiple sub-designs, generate physical modules having self-contained physical definitions corresponding to the sub-designs, and reassemble the physical modules into a reassembled physical netlist 303. The physically-aware partitioning unit 330 also can utilize the physical hierarchy to partition the circuit design 301, regroup the partitions of the circuit design 301 into a modified circuit design 304, and synthesize the modified circuit design 304 into a modified netlist 305.

The synthesis tool 300 can output the reassembled physical netlist 303 or the modified netlist 305, for example, to one or more downstream place-and-route tools. These downstream place-and-route tools can utilize the reassembled physical netlist 303 or the modified netlist 305 to generate a layout design for the electronic system. Since both of the reassembled physical netlist 303 and the modified netlist 305 are organized according to the physical hierarchy, the downstream place-and-route tools can assign modules in the reassembled physical netlist 303 or and the modified netlist 305 to a physical regions based on their physical hierarchy and then utilize the physical region assignments to place components together in the layout design. The synthesis tool 300 also can output the modified circuit design 304, for example, to a formal verification tool to check an equivalence of the modified circuit design 304 to the circuit design 301.

The physically-aware partitioning unit 330 can include an exploration unit 332 to identify how to divide or partition the physical representation of the circuit design 301 into sub-designs. In some embodiments, the division or partitioning of the physical representation of the circuit design 301 can be based on characteristics of interfaces between modules in the physical representation of the circuit design 301. The exploration unit 332 can identify connectivity between the modules in the physical representation of the circuit design 301 and results of a timing analysis, which can be utilized to determine how to partition the physical representation of the circuit design 301. In some embodiments, the division or partitioning of the physical representation of the circuit design 301 can be based on other considerations, such as a size of the resulting sub-designs or partitions, the logical hierarchy of the circuit design 301, or the like.

The synthesis tool 300 may include a timing analysis unit 340 to perform the timing analysis on the physical representation of the circuit design 301. In some embodiments, the timing analysis unit 340 can determine timing of clock and data signals in the physical representation of the circuit design 301 during the timing analysis. The exploration unit 332 can compare the results of the timing analysis to the timing constraints in the constraints 302 of the circuit design 301 to identify any timing violations in the physical representation of the circuit design 301. For example, the timing violations can include one or more measures of negative slack associated with the interfaces or the modules. The exploration unit 332, in some embodiments, can select partitions at interfaces between modules having less connectivity and fewer, if any, timing violations. The exploration unit 332 also can present the interface characteristics, such as connectivity and timing violations, and possibly suggested partitions via a user interface and receive selection of one or more interfaces to utilize as partitions.

The physically-aware partitioning unit 330 can include a realization unit 334 to determine a physical hierarchy for the physical representation of the circuit design 301 based on the partitions determined by the exploration unit 332. The realization unit 334 can generate physical modules for each of the sub-designs identified in the physical hierarchy. Each of the physical modules can have a corresponding logical module from the circuit design 301 or gate-level netlist and have a corresponding self-contained physical definition, such as physical boundaries, placement of pins, regions identification, group identification, blockages, or the like. The physical modules can include portions of the circuit design 301, the gate-level netlist, and/or the physical representation. The realization unit 334 can generate constraints, such as power constraints, timing constraints, design for test constraints, or the like, tailored to the physical modules.

The realization unit 334 also can utilize the physical hierarchy for the physical representation of the circuit design 301 to restructure or modify the circuit design 301. For example, the realization unit 334 can regroup logical modules in the circuit design 301 into an organization corresponding to the physical hierarchy. This modified circuit design 304 can be synthesized into a gate-level netlist, such as the modified netlist 305, which can be output from the synthesis tool 300.

The physically-aware partitioning unit 330 can include a reassembly unit 336 to build a top-level design or reassembled physical netlist 303 from the physical modules generated by the realization unit 334. The reassembled physical netlist 303 can have the timing constraints corresponding to the constraints 302. In some embodiments, the floorplanning unit 320 can utilize the reassembled physical netlist 303 to generate a new floorplan for the reassembled physical netlist 303, which also may be outputted from the synthesis tool 300.

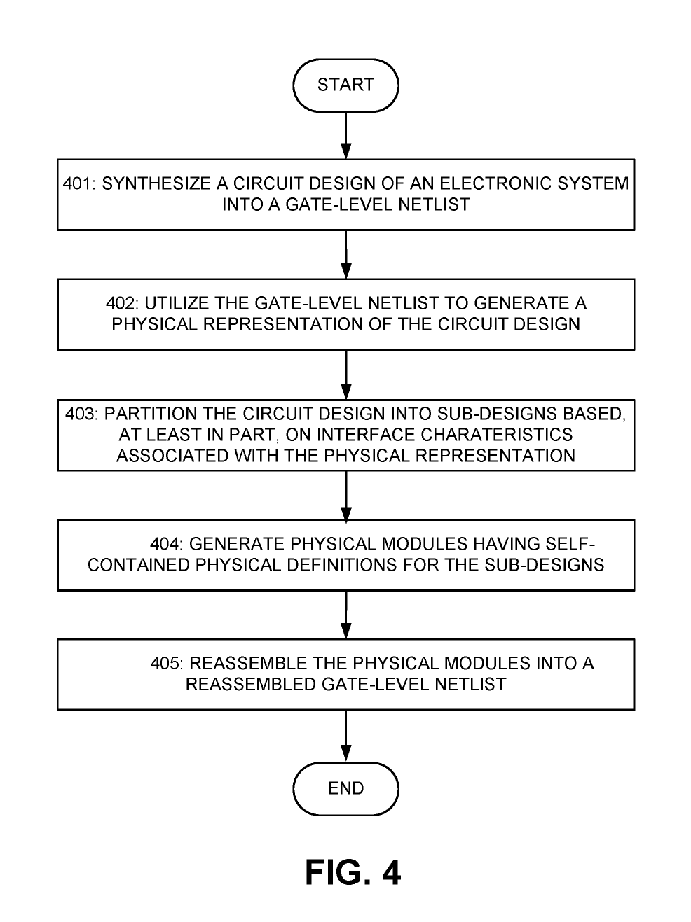

FIG. 4 illustrates an example flowchart showing physically-aware circuit design partitioning according to various examples of the invention. Referring to FIG. 4, in a block 401, a computing system implementing a synthesis tool can synthesize a circuit design of an electronic system into a gate-level netlist. The circuit design can model an electronic system at a register transfer level, and have multiple modules arranged in a logical hierarchy. The gate-level netlist can describe connectivity of components in the electronic system described by the circuit design, while retaining the logical hierarchy of the circuit design.

In a block 402, the computing system implementing the synthesis tool can utilize the gate-level netlist to generate a physical representation of the circuit design. The physical representation of the circuit design can be a floorplan of the circuit design, which can describe a tentative placement for the components in the gate-level netlist within a layout design.

In a block 403, the computing system implementing the synthesis tool can partition the circuit design into sub-designs based, at least in part, on interface characteristics associated with the physical representation. The interface characteristics can include connectivity between the modules in the physical representation of the circuit design and timing violations corresponding to the interfaces. For example, the timing violations can include one or more measures of negative slack associated with the interfaces or the modules. In some embodiments, the division or partitioning of the circuit design can be based on other considerations, such as a size of the resulting sub-designs or partitions, the logical hierarchy of the circuit design, or the like.

In a block 404, the computing system implementing the synthesis tool can generate physical modules having self-contained physical definitions for the sub-designs. Each of the physical modules can have a corresponding logical module from the circuit design 301 or gate-level netlist and have a corresponding self-contained physical definition, such as physical boundaries, placement of pins, regions identification, group identification, blockages, or the like. In some embodiments, the computing system implementing the synthesis tool can determine a physical hierarchy for the physical representation of the circuit design based on the partitions of the circuit design. The physical modules can include portions of the circuit design, the gate-level netlist, and/or the physical representation. The computing system implementing the synthesis tool can generate constraints, such as power constraints, timing constraints, design for test constraints, or the like, tailored to the physical modules.

In a block 405, the computing system implementing the synthesis tool can reassemble the physical modules into a reassembled gate-level netlist. For example, the computing system implementing the synthesis tool can build the reassembled gate-level netlist from the physical modules based on the physical hierarchy of the physical representation of the circuit design. Since the physical modules have self-contained physical descriptions, downstream place-and-route tools can assign instances within a physical module to a common region, and then utilize the region assignment to floorplan and place the instances together in a layout design for the electronic system.

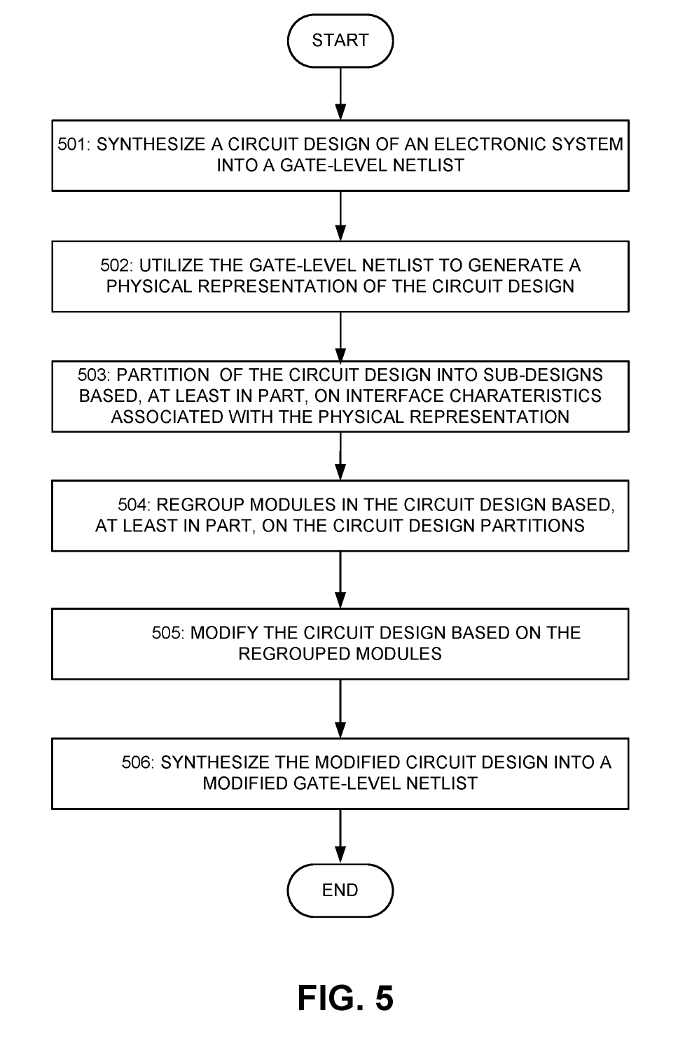

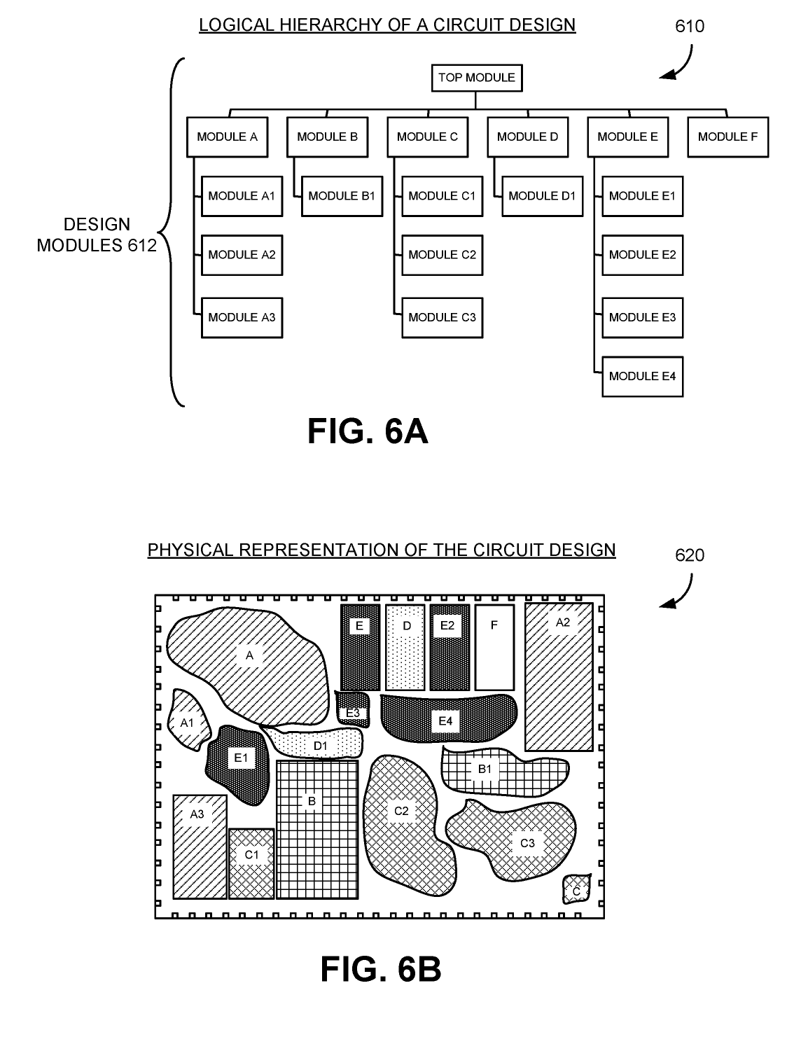

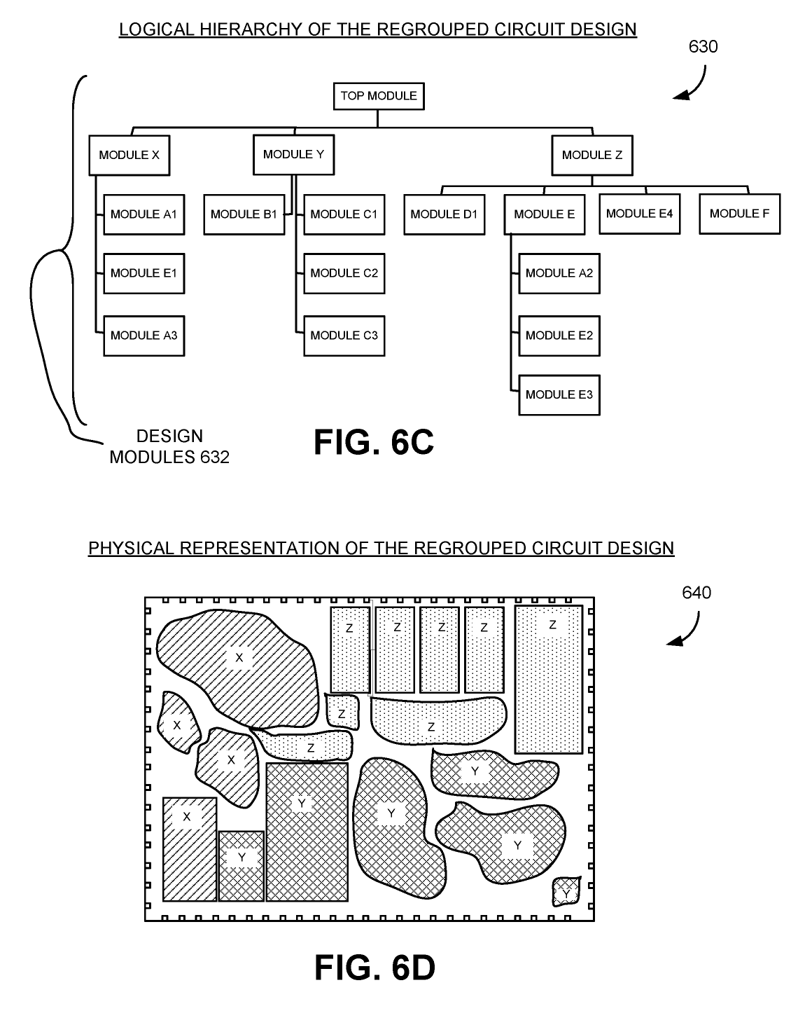

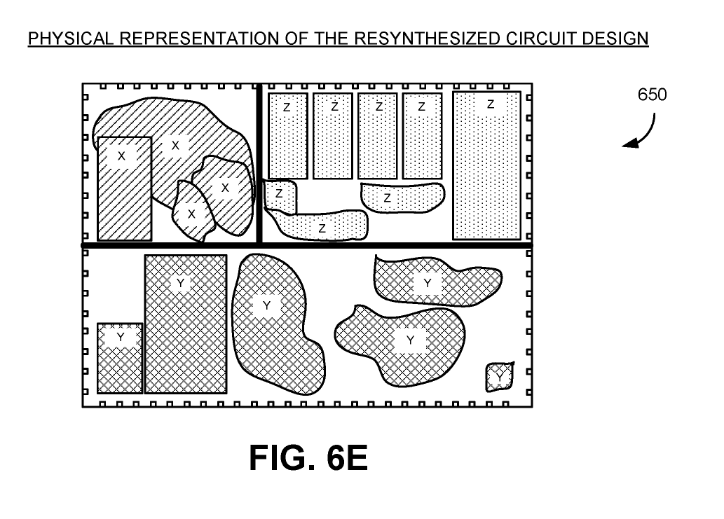

FIG. 5 illustrates another example flowchart showing physically-aware circuit design partitioning according to various examples of the invention. FIGS. 6A-6E illustrate examples of physically-aware circuit design partitioning according to various embodiments of the invention. Referring to FIG. 5 and FIGS. 6A-6E, in a block 501, a computing system implementing a synthesis tool can synthesize a circuit design of an electronic system into a gate-level netlist. The circuit design can model an electronic system at a register transfer level, and have multiple modules arranged in a logical hierarchy. The gate-level netlist can describe connectivity of components in the electronic system described by the circuit design, while retaining the logical hierarchy of the circuit design.

An example of the logical hierarchy 610 is shown in FIG. 6A. The logical hierarchy 610 can include multiple design modules 612 arranged in a tree-structure. The design modules 612 can have a top module interconnected to multiple child modules, such as modules A-F. Some of these child modules, such as modules A-E are interconnected to additional modules. Since the module F does not have any lower level modules interconnections, the module F can be a leaf module in the logical hierarchy.

In a block 502, the computing system implementing the synthesis tool can utilize the gate-level netlist to generate a physical representation of the circuit design. The physical representation of the circuit design can be a floorplan of the circuit design. An example of the physical representation of the circuit design as a floorplan 620 is shown in FIG. 6B. The floorplan 620 can model a physical layout of the design modules 612 in the logical hierarchy 610. The floorplan 620 can describe a tentative placement for the modules within a layout design.

In a block 503, the computing system implementing the synthesis tool can partition the circuit design into sub-designs based, at least in part, on interface characteristics associated with the physical representation. The interface characteristics can include connectivity between the modules in the physical representation of the circuit design and timing violations corresponding to the interfaces. For example, the timing violations can include one or more measures of negative slack associated with the interfaces or the modules. In some embodiments, the division or partitioning of the circuit design can be based on other considerations, such as a size of the resulting sub-designs or partitions, the logical hierarchy of the circuit design, or the like.

In a block 504, the computing system implementing the synthesis tool can regroup modules in the circuit design based, at least in part, on the circuit design partitions. In some embodiments, the partitioning of the circuit design into sub-designs can create a physical hierarchy based on the circuit design partitions. This physical hierarchy can assign the design modules 612 into different physical regions or physical groups, which the computing system implementing the synthesis tool can utilize to regroup the modules in the circuit design so that the modules are organized according to physical hierarchy.

An example of the logical hierarchy 630 for the regrouped circuit design is shown in FIG. 6C. The logical hierarchy 630 can include regrouped design modules 632 arranged in a tree-structure. The logical hierarchy 630 is similar to the logical hierarchy 610except the design modules 612 of FIG. 6A have been structured into regrouped design modules 632 based on the physical hierarchy associated with the circuit design partitions. An example of the physical representation of the circuit design as a floorplan 640 is shown in FIG. 6D. The floorplan 640 can model a physical layout of the regrouped design modules 632 in the logical hierarchy 630 into three different regions, X, Y, and Z corresponding to the hierarchies under modules X, Y, and Z, respectively. The floorplan 640 can describe a tentative placement for the modules within a layout design.

In a block 505, the computing system implementing the synthesis tool can modify the circuit design based on the regrouped modules. This modification of the circuit design can be a rewriting of the circuit design into a form having a logical hierarchy that corresponds to the physical hierarchy.

In a block 506, the computing system implementing the synthesis tool can synthesize the modified circuit design into a modified gate-level netlist having a hierarchy corresponding to the determined physical hierarchy. An example of the physical representation of the resynthesized circuit design as a floorplan 650 is shown in FIG. 6E. Since the modified gate-level netlist has a design module hierarchy that corresponds to the physical hierarchy determined above, the synthesis tool or a downstream place-and-route tool can generate a floorplan 650 having three distinct regions, X, Y, and Z corresponding to the hierarchies under modules X, Y, and Z, respectively, in the logical hierarchy 630 of the modified circuit design.

The processing device may execute instructions or “code” stored in memory. The memory may store data as well. The processing device may include, but may not be limited to, an analog processor, a digital processor, a microprocessor, a multi-core processor, a processor array, a network processor, or the like. The processing device may be part of an integrated control system or system manager, or may be provided as a portable electronic device configured to interface with a networked system either locally or remotely via wireless transmission.

The processor memory may be integrated together with the processing device, for example RAM or FLASH memory disposed within an integrated circuit microprocessor or the like. In other examples, the memory may comprise an independent device, such as an external disk drive, a storage array, a portable FLASH key fob, or the like. The memory and processing device may be operatively coupled together, or in communication with each other, for example by an I/O port, a network connection, or the like, and the processing device may read a file stored on the memory. Associated memory may be “read only” by design (ROM) by virtue of permission settings, or not. Other examples of memory may include, but may not be limited to, WORM, EPROM, EEPROM, FLASH, or the like, which may be implemented in solid state semiconductor devices. Other memories may comprise moving parts, such as a known rotating disk drive. All such memories may be “machine-readable” and may be readable by a processing device.

Operating instructions or commands may be implemented or embodied in tangible forms of stored computer software (also known as “computer program” or “code”). Programs, or code, may be stored in a digital memory and may be read by the processing device. “Computer-readable storage medium” (or alternatively, “machine-readable storage medium”) may include all of the foregoing types of memory, as well as new technologies of the future, as long as the memory may be capable of storing digital information in the nature of a computer program or other data, at least temporarily, and as long at the stored information may be “read” by an appropriate processing device. The term “computer-readable” may not be limited to the historical usage of “computer” to imply a complete mainframe, mini-computer, desktop or even laptop computer. Rather, “computer-readable” may comprise storage medium that may be readable by a processor, a processing device, or any computing system. Such media may be any available media that may be locally and/or remotely accessible by a computer or a processor, and may include volatile and non-volatile media, and removable and non-removable media, or any combination thereof.

A program stored in a computer-readable storage medium may comprise a computer program product. For example, a storage medium may be used as a convenient means to store or transport a computer program. For the sake of convenience, the operations may be described as various interconnected or coupled functional blocks or diagrams. However, there may be cases where these functional blocks or diagrams may be equivalently aggregated into a single logic device, program or operation with unclear boundaries.

### CONCLUSION

While the application describes specific examples of carrying out embodiments of the invention, those skilled in the art will appreciate that there are numerous variations and permutations of the above described systems and techniques that fall within the spirit and scope of the invention as set forth in the appended claims. For example, while specific terminology has been employed above to refer to electronic design automation processes, it should be appreciated that various examples of the invention may be implemented using any desired combination of electronic design automation processes.

One of skill in the art will also recognize that the concepts taught herein can be tailored to a particular application in many other ways. In particular, those skilled in the art will recognize that the illustrated examples are but one of many alternative implementations that will become apparent upon reading this disclosure.

Although the specification may refer to “an”, “one”, “another”, or “some” example(s) in several locations, this does not necessarily mean that each such reference is to the same example(s), or that the feature only applies to a single example.

1. A method comprising:
synthesizing, by a computing system, a circuit design of an electronic system into a first gate-level netlist having a logical hierarchy;
utilizing, by the computing system, the first gate-level netlist to generate a physical representation of the circuit design;
partitioning, by the computing system, the circuit design based, at least in part, on the physical representation of the circuit design; and
generating, by the computing system, a second gate-level netlist having a physical hierarchy corresponding to the partitions of the circuit design.

2. The method of claim 1, wherein partitioning the circuit design further comprising partitioning the circuit design, the first gate-level netlist, and the physical representation of the circuit design into sub-designs based, at least in part, on connectivity and timing violations of interfaces between modules in the physical representation of the circuit design.

3. The method of claim 2, wherein generating the second gate-level netlist further comprising:
generating physical modules from the sub-designs of the circuit design, the first gate-level netlist, and the physical representation of the circuit design; and
reassembling the physical modules into the second gate-level netlist.

4. The method of claim 1, wherein the physical modules have self-contained physical definitions based on constraints associated with the circuit design.

5. The method of claim 1, further comprising:
regrouping, by the computing system, modules in the circuit design based, at least in part, on the physical hierarchy corresponding to the partitions of the circuit design; and
modifying, by the computing system, the circuit design to have the physical hierarchy based on the regrouped modules.

6. The method of claim 5, wherein generating the second gate-level netlist further comprising synthesizing the modified circuit design into the second gate-level netlist having the physical hierarchy corresponding to the partitions of the circuit design.

7. The method of claim 1, wherein the physical representation of the circuit design corresponds to a floorplan that describes a tentative placement for components in the first gate-level netlist within a layout design.

8. A system comprising:
a memory device configured to store machine-readable instructions; and
a computing system including one or more processing devices, in response to executing the machine-readable instructions, configured to:
synthesize a circuit design of an electronic system into a first gate-level netlist having a logical hierarchy;
utilize the first gate-level netlist to generate a physical representation of the circuit design;
partition the circuit design based, at least in part, on the physical representation of the circuit design; and
generate a second gate-level netlist having a physical hierarchy corresponding to the partitions of the circuit design.

9. The system of claim 8, wherein the one or more processing devices, in response to executing the machine-readable instructions, are configured to partition the circuit design, the first gate-level netlist, and the physical representation of the circuit design into sub-designs based, at least in part, on connectivity and timing violations of interfaces between modules in the physical representation of the circuit design.

10. The system of claim 9, wherein the one or more processing devices, in response to executing the machine-readable instructions, are configured to:
generate physical modules from the sub-designs of the circuit design, the first gate-level netlist, and the physical representation of the circuit design; and
reassemble the physical modules into the second gate-level netlist.

11. The system of claim 8, wherein the physical modules have self-contained physical definitions based on constraints associated with the circuit design.

12. The system of claim 8, wherein the one or more processing devices, in response to executing the machine-readable instructions, are configured to:
regroup modules in the circuit design based, at least in part, on the physical hierarchy corresponding to the partitions of the circuit design; and
modify the circuit design to have the physical hierarchy based on the regrouped modules.

13. The system of claim 12, wherein the one or more processing devices, in response to executing the machine-readable instructions, are configured to synthesize the modified circuit design into the second gate-level netlist having the physical hierarchy corresponding to the partitions of the circuit design.

14. An apparatus comprising at least one computer-readable memory device storing instructions configured to cause one or more processing devices to perform operations comprising:
synthesizing a circuit design of an electronic system into a first gate-level netlist having a logical hierarchy;
utilizing the first gate-level netlist to generate a physical representation of the circuit design;
partitioning the circuit design based, at least in part, on the physical representation of the circuit design; and
generating a second gate-level netlist having a physical hierarchy corresponding to the partitions of the circuit design.

15. The apparatus of claim 14, wherein partitioning the circuit design further comprising partitioning the circuit design, the first gate-level netlist, and the physical representation of the circuit design into sub-designs based, at least in part, on connectivity and timing violations of interfaces between modules in the physical representation of the circuit design.

16. The apparatus of claim 15, wherein generating the second gate-level netlist further comprising:
generating physical modules from the sub-designs of the circuit design, the first gate-level netlist, and the physical representation of the circuit design; and
reassembling the physical modules into the second gate-level netlist.

17. The apparatus of claim 14, wherein the physical modules have self-contained physical definitions based on constraints associated with the circuit design.

18. The apparatus of claim 14, wherein the instructions configured to cause the one or more processing devices to perform operations further comprising:
regrouping modules in the circuit design based, at least in part, on the physical hierarchy corresponding to the partitions of the circuit design; and
modifying the circuit design to have the physical hierarchy based on the regrouped modules.

19. The apparatus of claim 18, wherein generating the second gate-level netlist further comprising synthesizing the modified circuit design into the second gate-level netlist having the physical hierarchy corresponding to the partitions of the circuit design.

20. The apparatus of claim 14, wherein the physical representation of the circuit design corresponds to a floorplan that describes a tentative placement for components in the first gate-level netlist within a layout design.
